(19) United States
(12) Patent Application Publication
(10) Pub. No.: US 2011/0284450 A1
(43) Pub. Date: Nov. 24, 2011

(54) Reusable Pads For Removing Liquid Contaminants

(76) Inventors: Daniel O'Blair Chadwick, Martin, TN (US); Kenneth Richard Lieblein, Boca Raton, FL (US)

(21) Appl. No.: 12/905,182

(22) Filed: Oct. 15, 2010

Related U.S. Application Data
(60) Provisional application No. 61/346,793, filed on May 20, 2010.

(51) Int. Cl. E02B 15/04; D05B 3/00; C02F 1/40; B01J 20/28; B01J 20/30; B01D 15/00; B01J 20/26

(52) U.S. Cl. 210/242.4; 112/475.17; 502/402; 210/232

(57) ABSTRACT

Quilted absorbent pad panel of cluster or ball fiber that contains: Polyester ball or cluster (spherical) fiber; Cotton/Polyester Water and Oil Permeable Fabrics; and attachment means. The fiber is laid out in a “wave”. Next, the “wave” of ball or cluster fiber must be placed and retained between two layers of cotton/polyester water/oil permeable fabric. To retain the fiber between the two layers of cotton/polyester water/oil permeable fabric a unique quilt is created. Unique quilting creates defined closed compartments in which the fiber and cotton polyester fabrics are affixed. Absorbent pad panels are used to absorb and remove oil from the surface of water. Siliconized polyester ball fibers are locked into the sewn compartments of the absorbent pad panels and passively draw the oil from the surface of the water and at the same time repel water so only oil is absorbed in an uncontaminated state.

### CROSS REFERENCE TO RELATED APPLICATIONS

This application claims priority from U.S. Patent Application Ser. No. 61/346,793, entitled “Reusable Pads For Removing Liquid Contaminants”, filed on 20 May 2010. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

This invention generally relates to a method for removing liquid contaminant from surfaces, especially for removing spilled oil from the surface of water. More specifically, the present invention relates to a method for removing liquid contaminant from a liquid surface by applying a pad which is a siliconized cluster or ball fiber retained between two quilted layers of cotton/polyester water/oil permeable fabric whereby defined closed compartments are created in which the fiber and cotton polyester fabrics are affixed. This invention also relates to a reusable pad for removing liquid contaminants from surfaces and a method for reusing the pad.

### BACKGROUND OF THE INVENTION

The first example of an oil-collecting device is set out in U.S. Pat. No. 3,739,913. This device includes a netting material formed into a hollow, cylindrical shaped container. Inside the container is a fiber mass. Preferred fiber materials include rayon, nylon, and cord reclaimed from old tires. Glass fibers may be added to keep the fiber mass fluffy and loose. Ends of the container are secured to a rope that extends centrally through an interior of the container.

Another oil absorbing devices is shown and discussed in U.S. Pat. No. 3,701,258. This second device includes an elongated oil mop in the form of an endless loop. The rope loop has a core that holds an array of outward extending oil absorbing fibers.

U.S. Pat. No. 4,031,839 discloses a reusable oil absorbing pad in which the absorbent pad is contained in an inner and an outer bag. The reusable pad consists of a particulate mass of expanded open pore resin, particularly of alternating layers of large (10,000 to 5,000 microns) medium (5,000 to 2,000 microns) and small (less than 2,000 microns) particles of expanded synthetic material such as rigid polyurethane foam. However, the assembly of the pads from separate components and the provision of particles of particular sizes adds production complexity and cost to the absorbent pad.

An oil absorbing mat, disclosed in U.S. Pat. No. 4,832,852, comprises a pair of a non-woven, cotton fiber webs spaced apart by a scrim sheet of woven polypropylene. Edges of the webs and sheet are stitched together with waxed threads.

U.S. Pat. No. 5,181,802 discloses an oil absorbing comprised by a set of modules. Each module includes a tubular shaped stocking formed of a mesh material that promotes liquid permeability. Extending along respective vertical side edges of each stocking is a wire having outward extending horizontal hooks. The hooks of adjacently positioned modules hold the modules together. Inside each stocking is a specially prepared wood fiber mass. This mass is compartmentalized by spaced apart partitions sewed into each stocking Seemingly, closure of ends of the stockings is effected by the wires.

U.S. Pat. No. 5,451,325 discloses a relatively thin flexible sheets of oleophilic, hydrophobic substrates, such as polyethylene film, are used as the basis for absorbent media in novel methods for defending against oil spills. Exhibiting the combination of a high storage density and a high affinity for oil, substrates according to the invention are intended for deployment on sensitive areas of open water or shoreline as a first line of defense against approaching oil slicks, or for early assistance in the containment of oil near the source of a spill. Efficiency and economy in specific applications is achieved on the principle that oil pick-up per unit mass of film-form substrates is increased by decreasing the substrate thickness. The substrate is deployed from a compact supply, in a pre-deployment condition of high storage density onto the area to be protected, in the course of which it is converted to a post-deployment, in-use condition of bulk capacity for oil. One or more layers of an absorbent material may be extended onto the oil-contaminated surface of an expanse of open water or may be extended onto a shoreline water or land area to be protected from approaching oil spills. Absorbent media used in carrying out the method of the invention may advantageously incorporate oil-degrading additives.

U.S. Pat. No. 5,965,030 discloses a method for removing liquid hydrocarbon from a water surface comprising: (a) forming a non-woven fabric; (b) applying a substantially continuous aqueous foam coating composition having an air to liquid ratio from 5 to 1 to 20 to 1 by volume, said coating composition comprising an emulsion polymer binder, to both sides of said nonwoven fabric; (c) drying said foam coating, wherein the density of said dried foam-coated mat is less than the density of water; and (d) contacting said liquid hydrocarbon contaminant with said dried foam coating, whereby said foamed coating absorbs at least some of said liquid hydrocarbon contaminant. However, the use of an aqueous foam coating adds production complexity and cost to the absorbent pad.

U.S. Pat. No. 6,312,596 discloses a bag, particularly adapted for absorbing hydrocarbons dispersed in smaller quantities of water, has a ball-like shaped body formed from oleophobic netting materials. The bag body includes a tubular-shaped outer sleeve positioned about a tubular-shaped inner sleeve to form an interior space there between. Adjacent end portions of each sleeve then are connected so that an absorbent medium in the bag interior space is fully enclosed. The inner sleeve defines a central passageway through the bag. To hold the bag during use, a cord loop may be disposed in the central passageway with a knotted end of the cord joined with one of the sleeve end portion connections. A looped end of the cord then extends from an opposite end of the central passageway to provide convenient means for attaching the bag to a support while the bag is immersed in a hydrocarbon-water mix. As hydrocarbons are drawn to strands of the bag netting and then collect in voids of the netting, the bag discolors. When sufficiently discolored, the bag is withdrawn for external cleaning or disposal.

Many materials are known to be oil-absorbent or oil adsorbent, such as wood chips, activated carbon, wool, cotton balls, corn husks, duck feathers, and various synthetic polymeric materials. A number of polymeric materials (polypropylene, polyester, polyurethane, vinyl polymers, and others) are known to absorb or adsorb crude or refined. Systems for applying these materials to oil spills are less developed and typically placing the material inside booms or other barriers that surround the spill.

These methods create severe collection problems for absorbent material in particulate form, including sinking of the oil-loaded material, loss of the oil-loaded material due to dispersion by wave or wind action, and dissolution of the oil absorbent material in the oil spill. These problems are exacerbated when the spill occurs in bad weather or near shorelines.

The problem faced by the inventors is the provision of an alternative method for removing liquid contaminant from a surface such as, for example, oil from the surface of ocean water with a reusable absorbent structure; a reusable absorbent pad suitable for removing liquid contaminant from a surface; and a method for reusing a pad suitable for removing liquid contaminant from a surface.

Therefore it is an objective of the present invention to teach an oil absorbent pad and collection method where the recovered oil product can be captured and used for its intended purpose.

### SUMMARY OF THE INVENTION

The present invention is a specially manufactured quilted panel of cluster or ball fiber that contains: (1) Polyester ball or cluster (spherical) fiber; (2) Cotton/Polyester Water and Oil Permeable Fabrics; and (3) attachment means such as grommets. In a preferred embodiment, the present invention is used to separate out and absorb oil mixed with water that is laying on the surface of water.

The process for creating the absorbent pad of the present invention for the purposes of separating out and absorbing oil mixed with water that is laying on the surface of water is as follows. First the ball or cluster fiber is laid out in a “wave”. Next, the “wave” of ball or cluster fiber must be placed and retained between two layers of cotton/polyester water/oil permeable fabric. To retain the ball or cluster fiber between the two layers of cotton/polyester water/oil permeable fabric a unique quilt is created. The unique quilt creates defined closed compartments in which the ‘sandwich’ of ball fiber and cotton polyester fabrics are affixed. The present invention also uses siliconized fiber to make our Cluster or Ball Fiber. Thus, captured oil is not diluted in sea or ocean water, it remains relatively pure. Thus, one advantage of this collection method is that the recovered oil product can be captured and used for its intended purpose.

Finally, attachment means such as grommets, loops, clamps, rings, or ropes on the edges of the panels are attached and provided to allow for one or more successive panels to be connected.

The absorbent pads of the present invention will have a heavy-duty webbing sewn to the perimeter of the pad. The Loops at the ends of pad-used to connect successive pads together—are attached to the heavy-duty webbing sewn to the perimeter of the pad. The Purpose of the Heavy Duty Webbing—is to protect and preserve the integrity of the pad—to Prevent the pad from ripping apart when pulled up to a servicing vessel for “wringing out” as the oil laden pad will be much heavier then during its deployment, which would be dry in a first use or wet after wringing.

To prevent tearing of the absorbent pad panels when laden with the weight of the collected oil, the absorbent pad panels are made with a heavy PVC coated reinforcing perimeter fabric that prevents the absorbent pad panels from tearing apart—when pulled from the water.

In a first embodiment of the present invention, the absorbent pad panels of the present invention are used to absorb and remove oil from the surface of water such as oceans, seas, lakes, and rivers. The siliconized polyester ball fibers are locked into the sewn compartments of the absorbent pad panels of the present invention. The fabric used is water and oil permeable. The siliconized ball fibers passively draw the oil from the surface of the water and at the same time repel water so only oil is absorbed in an uncontaminated state so that the oil can be recaptured. The present invention, when applied over oil on surface of water, will absorb the oil first and then repel water. If the present invention is applied to pure water with no oil, the present invention will absorb water—and act as an absorbent.

On a surface of oil covered water, the suggested use is to drag the absorbent pad panels of the present invention in trains around oil slick then bring the absorbent pad panels of the present invention in for squeezing and then reuse by repeating the process. Once drained of its contents via a press the absorbent pad panels of the present invention are just as absorbent as they were in their first use.

In still another embodiment, the absorbent pad panels of present invention are arranged in sizes up to 500 Lineal Feet Long with or without side bindings that can be put out into the ocean in long continuous lengths to mop up an oil slick. These 500 linear foot absorbent pad panels are then pulled across oil slicks for a period of time such as twenty minutes and then netted in and drawn onto a barge and put through an industrial “wringer” to retrieve the oil. Once the absorbent pad panels are rung, they are then put back into the oil slick and pulled across another long length of the oil slick for a period of time before re-wringing. The process can be repeated indefinitely until the oil slick is completely absorbed.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 illustrates the ball or cluster fiber laid out in a “wave”;

FIGS. 2-3 illustrates the unique quilt, which creates the defined closed compartments in which the ball fiber and cotton polyester fabrics are affixed;

FIG. 4 is a sectional view of a quilt showing the oil trapped in side a quilted pocket;

FIG. 5 is a diagram of the wringing process used by the present invention to separate/squeeze the oil out of the absorbent pads of the present invention; and

FIG. 6 illustrates a plurality of quilted absorbent pad panels connected to form a train for release into an oil spill and collection and wringing.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Now referring to the Figures, the embodiment of the reusable pad(s) for removing liquid contaminants are shown. The present invention is a specially manufactured quilted absorbent pad 300 comprised of cluster or ball fiber that contains a polyester ball or cluster (spherical) fiber 100; Cotton/Polyester Water and Oil Permeable Fabrics 301 and 302; and attachment means such as grommets 303. In a preferred embodiment, the present invention is used to separate out and absorb oil mixed with water that is laying on the surface of water.

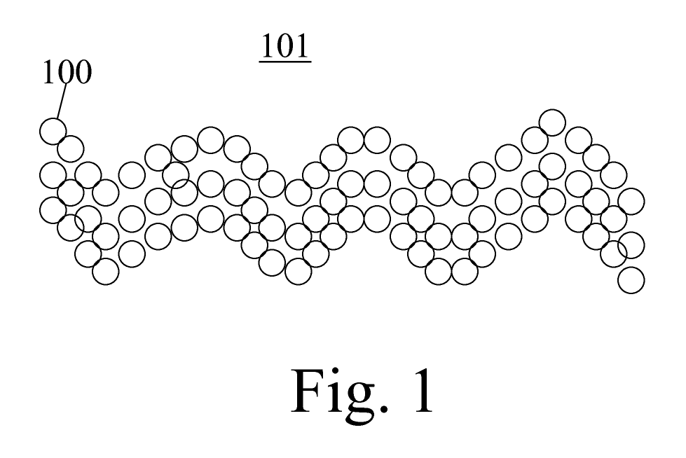

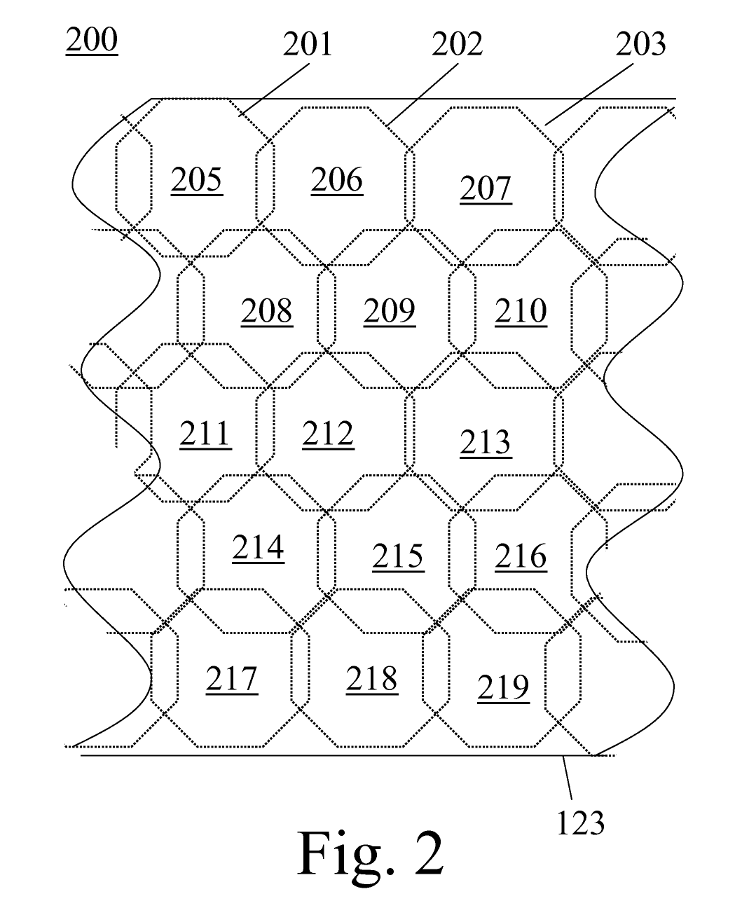

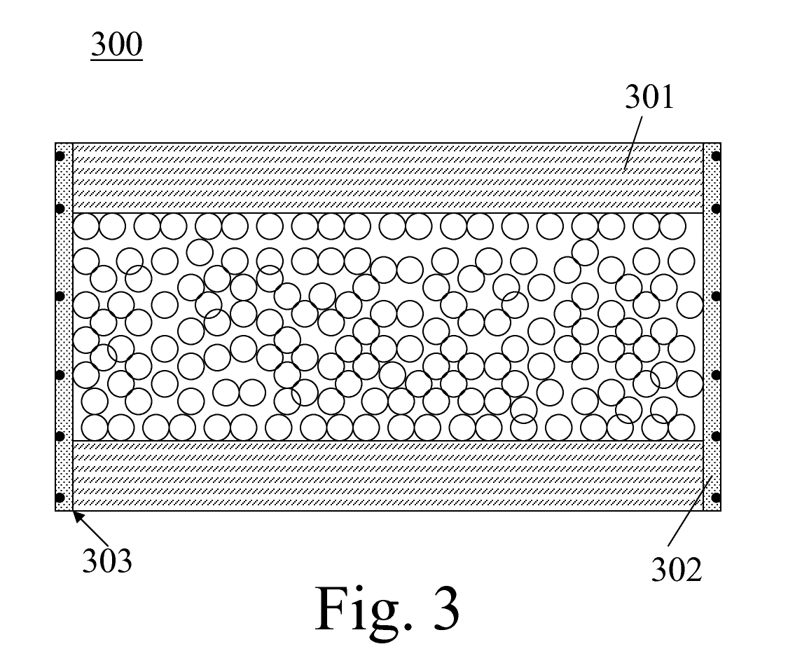

The process for creating the absorbent pad 300 of the present invention for the purposes of separating out and absorbing oil mixed with water that is laying on the surface of water is as follows. As shown in FIG. 1, first the ball or cluster fiber 100 is laid out in a “wave” 101. Next, the “wave” 100 of ball or cluster fiber 101 must be placed and retained between two layers of cotton/polyester water/oil permeable fabric 301 and 302 as shown in FIG. 3. To retain the ball or cluster fiber 100 between the two layers of cotton/polyester water/oil permeable fabric 301 and 302 a unique quilt 200 is created. The unique quilt 200 creates defined closed compartments 205, 206, 207, 208, 209, 210, 211, 212, 213, 214, 215, 216, 217, 218, and 219 in which the ‘sandwich’ of ball fiber 100 and cotton polyester fabrics 301 and 302 are affixed. The present invention is specially manufactured. The sew patterns 201, 202, and 203 used will vary in shape from circles to diamonds, curved rectangles, and other geometric shapes such as a square, octagon, pentagon, rectangle, triangle, circle, hexagon, and heptagon. Octagonal shaped closed compartments 205, 206, 207, 208, 209, 210, 211, 212, 213, 214, 215, 216, 217, 218, and 219 are illustrated in FIG. 2. All will be closed compartments 205, 206, 207, 208, 209, 210, 211, 212, 213, 214, 215, 216, 217, 218, and 219, which will help prevent flows of liquids or ball fiber 100 from one compartment to the other.

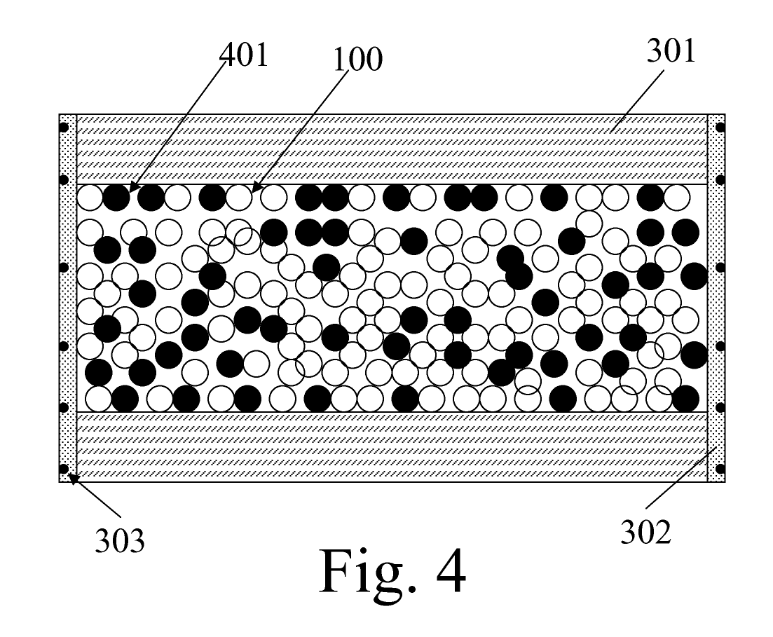

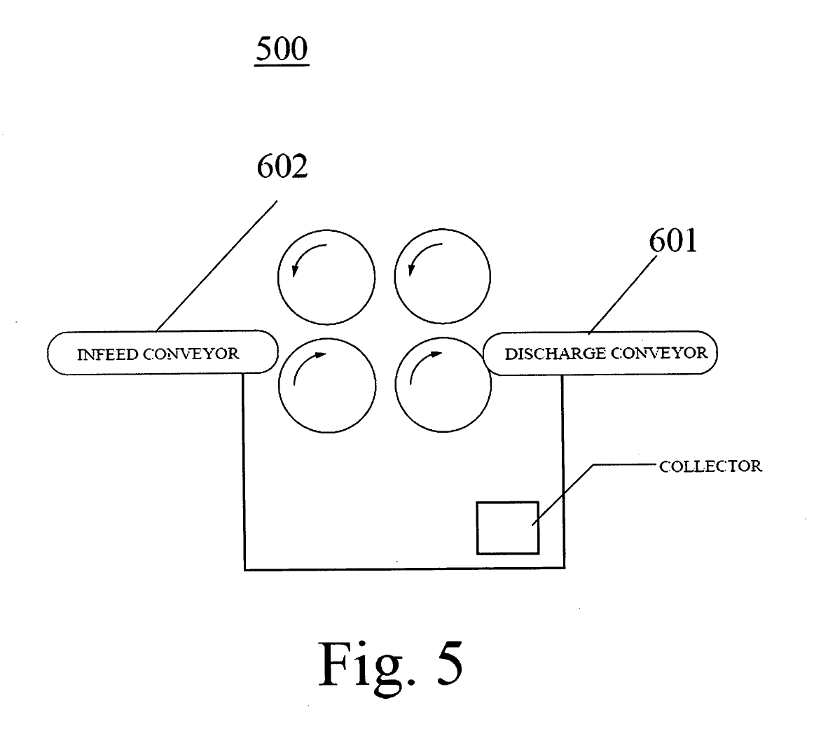

The present invention also uses siliconized fiber to make the cluster or ball fiber 100. It is the siliconizing of the cluster or ball fiber 100 that provides water repulsion and eliminates or greatly minimizes the absorption of water into the absorbent pad 123. Thus, captured oil is not diluted in sea or ocean water, it remains relatively pure. Thus, one advantage of this collection method is that the recovered oil product can be captured and used for its intended purpose. The present invention, when applied over oil on surface of water, will absorb the oil first as shown in FIG. 4 and then repel water. If the present invention is applied to pure water with no oil, the present invention will absorb water—and act as an absorbent.

This individual compartments also create a fail safe feature as each quilted closed compartments 205, 206, 207, 208, 209, 210, 211, 212, 213, 214, 215, 216, 217, 218, and 219 of the absorbent pad 300 of the present invention is independent, if one compartment of the absorbent pad 300 of the present invention is punctured, it does not effect the oil stored in the other compartments, minimizing the potential leakage or damage if one or more of the closed compartments 205, 206, 207, 208, 209, 210, 211, 212, 213, 214, 215, 216, 217, 218, and 219 is damaged by the environment or during wringing. Additionally, the absorbent pad 300 of the present invention will not sink. The air in the individual compartments 205, 206, 207, 208, 209, 210, 211, 212, 213, 214, 215, 216, 217, 218, and 219 which is naturally present during the manufacturing process and the oil 401 drawn into the compartments provides the necessary flotation, even when completely saturated. As oil 401 is soaked into bottom of an absorbent pad panel 300, air pockets grow in top of each sewn compartment—which adds infinite buoyancy to the absorbent pad panel 300.

Finally, attachment means such as grommets, loops, clamps, rings, or ropes 303 on the edges of the panels 300 are attached and provided to allow for one or more successive panels to be connected. The present invention includes a variety of mechanisms to connect one to the next. These connecting devises will include Grommets or Loops 304 but it should be appreciated that other connection means know in the art could be used.

The absorbent pads 300 of the present invention will have a heavy-duty webbing 302 sewn to the perimeter of the pad 300. The Loops 304 at the ends of pad-used to connect successive pads together—are attached to the heavy-duty webbing 302 sewn to the perimeter of the pad 300. The purpose of the heavy-duty webbing 302 is to protect and preserve the integrity of the pad—to prevent the pad from ripping apart when pulled up to a servicing vessel for “wringing out” as the oil laden pad will be much heavier then during its deployment, which would be dry in a first use or wet after wringing.

To prevent tearing of the absorbent pad panels when laden with the weight of the collected oil, the absorbent pad panels 300 are made with a heavy PVC coated reinforcing perimeter fabric 302 that prevents the absorbent pad panels 300 from tearing apart—when pulled from the water. The specs on the reinforcing border materials are as follows: PVC Coated Fabric; Mildew and Ultra Violet Resistant which is important as the absorbent pad panels will be used in full sun light for extended periods of time and re-uses; Grap Tensile Strength: Warp 400; Fill 430#; Strip Tensile Strength: Warp 520#'s; Fill 575#'s; Tongue Tear Strength: Warp 80#'s; Fill 85#'s; Hydro Resistance 600 psi; Low Temperature: −40 degrees F. which makes the absorbent pad panels good for all areas of the world.

The process for practicing the present invention for the purposes of separating out and absorbing oil mixed with water that is laying on the surface of water is as follows. Panels 601, 602, 603, 604 are strung together with any mechanical connecting material 605 such as nylon rope and metal rings and strung out into long ‘trains’ 606 in the water 608 or on a shoreline. The panels 601, 602, 603, 604 draw oil 607 off the surface of the water 608 and this oil 607, sometimes mixed with water 608, is held or held in storage in the sewn quilted closed compartments 205, 206, 207, 208, 209, 210, 211, 212, 213, 214, 215, 216, 217, 218, and 219 of each panel. Within these sewn closed compartments 205, 206, 207, 208, 209, 210, 211, 212, 213, 214, 215, 216, 217, 218, and 219, the oil 607 is actually held in the interior of the ball or cluster Fiber 100. A user then “wrings out” the oil/water that is absorbed with a wringer devise 500 and then returns the panels 601, 602, 603, 604 draw oil 607 back to the ocean as they are ready to start absorbing oil again. The panels 601, 602, 603, 604 draw oil 607 must be placed on top of the oil slick 607 located in the body of water 608.

The present invention, when applied over oil 607 on the surface of water 608, will absorb the oil 607 first and then repel water 608. If the present invention is applied to pure water with no oil, the present invention will absorb water—and act as an absorbent. The panels 601, 602, 603, 604 draw oil 607 are highly absorbent and can not be dragged into place, as they would absorb and retain the water 608 before reaching the oil 607 floating above the water 608.

In a preferred embodiment of the present invention, the absorbent pad panels of the present invention are 60″×80″×approximately 2″ thick and weigh approximately 7.7 pounds, but it is obvious to one of ordinary skill in the art that any size or a variety of sizes can easily be manufactured as desired. In a preferred embodiment, the pads are placed directly over or on top of the oil floating over the water surface. In this embodiment, the pads rest over the oil, and the oil is absorbed directly into them, minimizing water absorption and providing for a more efficient and quicker clean up. Thus, one advantage of this collection method is that the recovered oil product can be captured and used for its intended purpose.

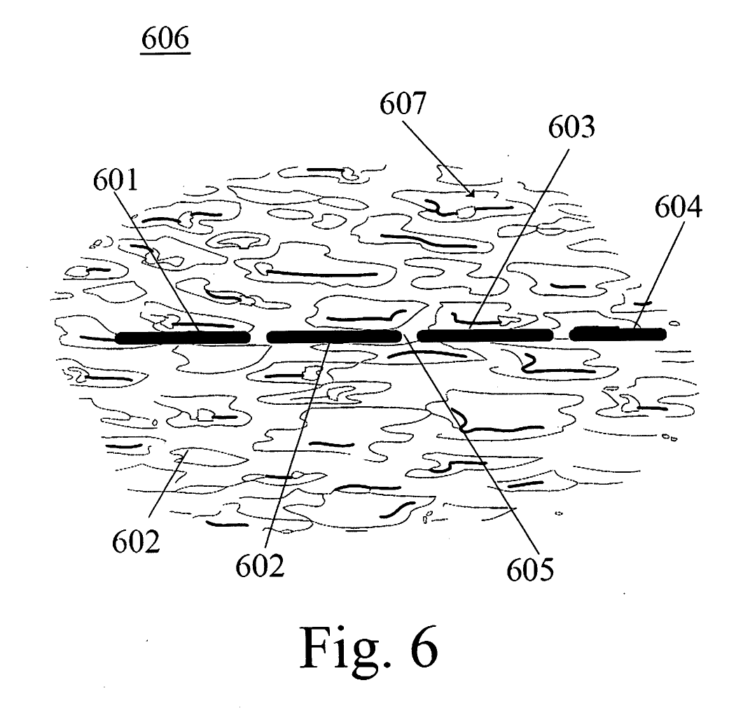

In a first embodiment of the present invention as shown in FIG. 6, the absorbent pad panels 601, 602, 603, 604 draw oil 607 of the present invention are used to absorb and remove oil 607 from the surface of water 608 such as oceans, seas, lakes, and rivers. The siliconized polyester ball fibers are locked into the sewn compartments of the absorbent pad panels of the present invention. The fabric used is water and oil permeable. The siliconized ball fibers passively draw the oil from the surface of the water and at the same time repel water so only oil is absorbed in an uncontaminated state so that the oil can be recaptured. On a surface of oil 607 covered water 608, the suggested use is to drag the absorbent pad panels 601, 602, 603, 604 draw oil 607 of the present invention in trains 606 around oil slick 607 then bring the absorbent pad panels 601, 602, 603, 604 of the present invention in for squeezing by a wringer 500 and then reuse by repeating the process. Once drained of its contents via a wringer 500 the absorbent pad panels 601, 602, 603, 604 of the present invention are just as absorbent as they were in their first use.

In an alternative embodiment as shown in FIG. 7, the absorbent pad panels 701, 702, 703, 704 of the present invention can be staked to the shoreline where they absorb oil as it rushes to shore. In this embodiment, the absorbent pad panels 701, 702, 703, 704 are attached to a boom 700 used to stop the spread or contain an oil spill 701.

In yet an alternative embodiment, the absorbent pad panels of the present invention may be used to absorb fresh water. In this embodiment, the absorbent pad panels of present invention are used to absorb fresh water during river flooding. Without the presence of oil, and by simply using siliconized ball fibers, the present invention can be used to absorb large volumes of water in homes or other areas.

In still another embodiment, the absorbent pad panels 601, 602, 603, 604 of present invention are arranged in sizes up to 500 Lineal Feet Long with or without side bindings that can be put out into the ocean in long continuous lengths to mop up an oil slick. The absorbent pad panels are then pulled across oil slicks for a period of time such as twenty minutes and then netted in and drawn onto a barge and put through an industrial “wringer” 500 to retrieve the oil. Once the absorbent pad panels are rung, they are then put back into the oil slick and pulled across another long length of the oil slick for a period of time before re-wringing. The process can be repeated indefinitely until the oil slick is completely absorbed. Basically, this process is a continuously run wringer 500, whereby the absorbent pad panels 601, 602, 603, 604 may be in any length and are carried to the wringer 500 either by hand or via a conveyor. Then the absorbent pad panels 601, 602, 603, 604 are sent through NEOPRENE covered wringer rollers 501 which are approximately 84″ in width that wring out the oil and collect the oil in a reservoir 502 and then the squeezed out absorbent pad panels 601, 602, 603, 604 are put back into sea to repeat the process.

In yet another embodiment, the absorbent panels may be used under boats or any oil covered object that has been covered or subjected to oil. During the cleaning of such an object, the removal of oil from the object done by washing or rinsing can be completed over one or more panels of the absorbent panels which then catch the oil and water coming off the object during cleaning or rinsing and capture the oil and water which is then easily separated by using a ringer.

In experiments, an absorbent 60″×80″ pad panel of the present invention with heavy duty perimeter webbing and loops for attaching successive pads on all sides absorbed two gallons of oil in ten minutes. An 8′×10′ Pool was filled with clear water and then two gallons of gear oil was added and agitated in the water—to simulate waves. Within ten minutes the absorbent 60″×80″ pad panel of the present invention absorbed and collected/retrieved the two gallons of gear oil and the water was left absolutely clear.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A reusable pads for removing liquid contaminants comprising:
a quilted absorbent pad panel of cluster or ball fiber that contains:
an interior section of a plurality of polyester ball or spherical cluster fibers;
an exterior section of cotton and polyester water and oil permeable fabrics that surrounds and retains the interior section;
and attachment means for securing one or more panels together attached to the exterior section;
the fiber is laid out in a wave;
the wave of ball or cluster fiber is placed and retained between two layers of cotton/polyester water/oil permeable fabric;
to retain the fiber between the two layers of cotton/polyester water/oil permeable fabric a quilt is created; and
quilting creates defined closed compartments in which a plurality of polyester ball or spherical cluster fibers are surrounded and retained within the two layers of cotton/polyester water/oil permeable fabric.

2. The reusable pads for removing liquid contaminants of claim 1, wherein
the defined closed compartments created by the quilting creates a plurality of independent and individual quilted compartments within the absorbent pad; and
wherein if one compartment of the absorbent pad of the present invention is punctured, it does not effect the oil stored in the other compartments.

3. The reusable pads for removing liquid contaminants of claim 1, further comprising
siliconized polyester ball fibers locked into the closed compartments of the absorbent pad panels which passively draw the oil from the surface of the water and at the same time repel water so only oil is absorbed in an uncontaminated state.

4. The reusable pads for removing liquid contaminants of claim 1, wherein the attachment means for securing one or more panels together are attached to the exterior section and consist of grommets.

5. The reusable pads for removing liquid contaminants of claim 1, wherein the attachment means for securing one or more panels together are attached to the exterior section and consist of grommets, loops, clamps, rings, or ropes on the edges of the panels are attached and provided to allow for one or more successive panels to be connected

6. The reusable pads for removing liquid contaminants of claim 1, wherein the cluster or ball fiber is siliconized.

7. The reusable pads for removing liquid contaminants of claim 1, further comprising:
a heavy-duty webbing sewn to the perimeter of the pad;
means for securing one or more panels together are attached to the exterior section and consist of loops at the ends of pad;
said loops are used to connect successive pads together; and
said loops are attached to the heavy-duty webbing sewn to the perimeter of the pad.

8. The reusable pads for removing liquid contaminants of claim 7, further comprising a heavy PVC coated reinforcing perimeter fabric.

9. The reusable pads for removing liquid contaminants of claim 1, wherein the quilting patterns used will vary in geometric shape.

10. The reusable pads for removing liquid contaminants of claim 1, wherein the same quilting pattern of a desired geometric shape is repeated for the entire pad.

11. The reusable pads for removing liquid contaminants of claim 10, wherein the quilting pattern is either a square, octagon, pentagon, rectangle, triangle, circle, hexagon, heptagon.

12. The reusable pads for removing liquid contaminants of claim 2, wherein
when applied over oil on surface of water will absorb the oil first and then repel water;
within the defined closed compartments created by the quilting, the oil is held in the interior of the ball or cluster Fiber; and
as oil is soaked into the bottom of the independent and individual quilted compartments within the quilted absorbent pad panel, air pockets grow in top of each independent and individual quilted compartments which adds buoyancy to the quilted absorbent pad panel.

13. The reusable pads for removing liquid contaminants of claim 7, wherein
a plurality of quilted absorbent pad panels with securing means are attached together via the securing means and placed into a body of water in long continuous lengths.

14. The reusable pads for removing liquid contaminants of claim 8 comprising in combination
an industrial wringer to release the oil from the closed compartments; and
wherein the plurality of quilted absorbent pad panels are pulled across an oil slick for a period of time and then netted in and drawn onto a barge and put through the industrial wringer to release the oil from the closed compartments and recover and stored the collected oil in a reservoir.

15. The reusable pads for removing liquid contaminants of claim 14 comprising in combination an industrial wringer wherein
once the quilted absorbent pad panels are rung, the quilted absorbent pad panels are then put back into the oil slick and pulled across another length of the oil slick for a period of time before re-wringing; and
the process is repeated until the oil slick is completely absorbed.

16. The reusable pads for removing liquid contaminants of claim 14, wherein
a plurality of the quilted absorbent pad panels are staked to a shoreline where they absorb oil as it rushes to shore; and
the quilted absorbent pad panels are attached to a boom used to stop the spread or contain an oil spill.

17. The reusable pads for removing liquid contaminants of claim 14, wherein
a plurality of the quilted absorbent pad panels are used to absorb water during a flooding incident; and
the quilted absorbent pad panels are stacked or otherwise exposed to the excess water and used to absorb the excess water.

18. Method of manufacturing a reusable absorbent pad for removing liquid contaminants comprising the steps of:
laying ball or cluster fiber out in a wave;
placing the wave of ball or cluster fiber between two layers of cotton/polyester water/oil permeable fabric;
retaining the ball or cluster fiber between the two layers of cotton/polyester water/oil permeable fabric; and
creating a quilt stitching that defines closed compartments in which the ball fiber and cotton polyester fabrics are affixed.

19. The method of manufacturing a reusable absorbent pad for removing liquid contaminants of claim 18 further comprising the steps of:
securing attachment means for securing one or more panels together to at least one of the layers of cotton/polyester water/oil permeable fabric.

20. The method of manufacturing a reusable absorbent pad for removing liquid contaminants of claim 19 further comprising the steps of:
attaching a heavy-duty webbing sewn to the perimeter of the pad affixed to at least one of the layers of cotton/polyester water/oil permeable fabric;
attaching loops at the ends of pad to the heavy-duty webbing sewn to the perimeter of the pad; and
securing one or more panels together to connect successive pads together.
